(19) United States
(12) Patent Application Publication
(10) Pub. No.: US 2025/0215917 A1
(43) Pub. Date: Jul. 3, 2025

(54) FASTENER AND METHOD OF MAKING AND USING THE SAME

(71) Applicant: SAINT-GOBAIN PERFORMANCE PLASTICS CORPORATION, Solon, OH (US)

(72) Inventors: Christopher DENOVEVA, Bristol (GB); Matthew SMITH, Midsomer Norton (GB)

(21) Appl. No.: 19/001,952

(22) Filed: Dec. 26, 2024

Related U.S. Application Data
(60) Provisional application No. 63/615,648, filed on Dec. 28, 2023.

(51) Int. Cl. F16B 21/07

(52) U.S. Cl. CPC F16B 21/076; F16B 2200/50

(57) ABSTRACT

A fastener including: a sidewall oriented about a central axis, the sidewall including at least one of 1) at least one first type of deformable projection comprising a teardrop shaped radial face, or 2) an arcuate portion, a radial corrugation portion, and a circumferential corrugation portion, where the sidewall is a layered structure including a substrate and an insulating layer overlying the substrate.

### CROSS-REFERENCE TO RELATED APPLICATION(S)

This application claims priority under 35 U.S.C. § 119(e) to U.S. Provisional Application No. 63/615,648, entitled “FASTENER AND METHOD OF MAKING AND USING THE SAME,” by Christopher DENOVEVA et al., filed Dec. 28, 2023, which is assigned to the current assignee hereof and incorporated herein by reference in its entirety.

### FIELD OF THE DISCLOSURE

This disclosure generally relates to fasteners and, in particular, to fasteners for attaching neighboring components.

### BACKGROUND

Commonly, fasteners constrain relative movement to the desired motion and reduce friction between neighboring components. One type of fastener may be located in a gap between an inner component and an outer component within an assembly. Exemplary assemblies may include door, hood, tailgate, engine compartment hinges, seats, steering columns, flywheels, driveshaft assemblies, seatback assemblies, airbag assemblies, or may include other assemblies, notably those used in automotive applications. Sometimes, there exists a need to fulfill stiffness and sliding/retention force requirements across components such as the inner component (such as an airbag component) and the outer component (such as a neighboring seatback component) in such an exemplary assembly. Therefore, there exists an ongoing need for improved fasteners that provide improved stiffness and sliding/retention force while maintaining a longer lifetime of the assembly.

### BRIEF DESCRIPTION OF THE DRAWINGS

The present disclosure may be better understood, and its numerous features and advantages made apparent to those skilled in the art by referencing the accompanying drawings.

FIG. 1 includes a method of producing a fastener in accordance with an embodiment;

FIG. 2A includes a cross-sectional view of a composite material that may form a fastener in accordance with an embodiment;

FIG. 2B includes a cross-sectional view of a composite material that may form a fastener in accordance with an embodiment;

FIG. 2C includes a cross-sectional view of a composite material that may form a fastener in accordance with an embodiment;

FIG. 3A includes a side perspective view illustration of a fastener in accordance with an embodiment;

FIG. 3B includes a top view illustration of a fastener in accordance with an embodiment;

FIG. 3C includes a top perspective view of a fastener within an assembly in accordance with an embodiment;

FIG. 3D includes a cross-sectional side view of a fastener within an assembly in accordance with an embodiment;

FIG. 3E includes a top perspective side view of an inner component within an assembly in accordance with an embodiment;

FIG. 3F includes a cross-sectional side view of an inner component within an assembly in accordance with an embodiment;

FIG. 4A includes a side perspective view illustration of a fastener in accordance with an embodiment;

FIG. 4B includes an end view illustration of a fastener in accordance with an embodiment;

FIG. 4C includes a side view of a fastener within an assembly in accordance with an embodiment;

FIG. 4D includes a cross-sectional side view of a fastener within an assembly in accordance with an embodiment;

FIG. 5A includes a side perspective view illustration of a fastener in accordance with an embodiment;

FIG. 5B includes a top view illustration of a fastener in accordance with an embodiment;

FIG. 5C includes a top perspective view of a fastener within an assembly in accordance with an embodiment; and

FIG. 5D includes a cross-sectional top view of a fastener within an assembly in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the fastener and fastener assembly arts.

Embodiments of the invention may include: A fastener including: a sidewall oriented about a central axis, the sidewall including at least one first type of deformable projection including a teardrop shaped radial face.

Embodiments of the invention may include: A fastener including: a sidewall oriented about a central axis, the sidewall including an arcuate portion, a radial corrugation portion, and a circumferential corrugation portion, where the sidewall is a layered structure including a substrate and an insulating layer overlying the substrate, where the fastener is adapted to secure an airbag to a frame of an assembly.

Embodiments of the invention may further include: An assembly including: an outer component including a bore within the outer component; an inner component disposed within the bore; and a fastener mounted between the inner component and the outer component, the fastener including: a sidewall oriented about a central axis, the sidewall including at least one first type of deformable projection including a teardrop shaped radial face.

Embodiments of the invention may further include: An assembly including: an outer component including an airbag; an inner component including a frame; and a fastener mounted between the inner component and the outer component, the fastener including: a sidewall oriented about a central axis, the sidewall including an arcuate portion, a radial corrugation portion, and a circumferential corrugation portion, where the sidewall is a layered structure including a substrate and an insulating layer overlying the substrate.

Embodiments of the invention may further include: A method including: providing an inner component and an outer component; positioning a fastener between the inner component and the outer component, the fastener including: a sidewall oriented about a central axis, the sidewall including at least one first type of deformable projection including a teardrop shaped radial face; and contacting the sidewall of the fastener to at least one of the inner component or the outer component.

Embodiments of the invention may further include: A method including: providing an inner component including an airbag and an outer component including a frame; positioning a fastener between the inner component and the outer component, the fastener including: a sidewall oriented about a central axis, the sidewall including an arcuate portion, a radial corrugation portion, and a circumferential corrugation portion, where the sidewall is a layered structure including a substrate and an insulating layer overlying the substrate; and contacting the sidewall of the fastener to at least one of the inner component or the outer component so as to fix the radial corrugation portion against the outer component.

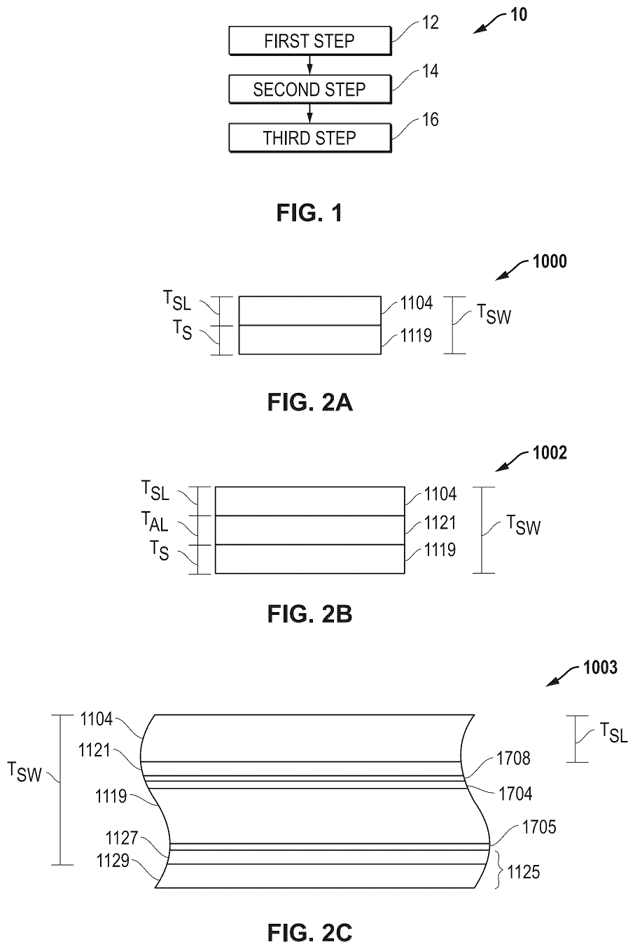

For purposes of illustration, FIG. 1 includes a method of producing a fastener in accordance with an embodiment described above. The forming process 10 may include a first step 12 of providing a base material, a second step 14 of coating the base material with a low friction coating to form a composite material and a third step 16 of forming the composite material into a fastener.

Referring to the first step 12, the base material may be a substrate. In an embodiment, the substrate can at least partially include a metal. According to certain embodiments, the metal may include iron, copper, titanium, tin, aluminum, alloys thereof, or may be another type of material. More particularly, the substrate can at least partially include a steel, such as, a stainless steel, carbon steel, or spring steel. For example, the substrate can at least partially include a 301 stainless steel. The 301 stainless steel may be annealed, ¼ hard, ½ hard, ¾ hard, or full hard. Moreover, the steel can include stainless steel including chrome, nickel, or a combination thereof. A particular stainless steel is 301 stainless steel. The substrate may include a woven mesh or an expanded metal grid. Alternatively, the woven mesh can be a woven polymer mesh. In an alternate embodiment, the substrate may not include a mesh or grid. The substrate may include conductive material.

In a number of embodiments, the substrate may be spring steel. The spring steel substrate may be annealed, ¼ hard, ½ hard, ¾ hard, or full hard. The spring steel substrate may have a tensile strength of not less than 600 MPa, such as not less than 700 MPa, such as not less than 750 MPa, such as not less than 800 MPa, such as not less than 900 MPa, or such as not less than 1000 MPa. The spring steel substrate may have a tensile strength of no greater than 1500 MPa, or such as no greater than 1250 MPa.

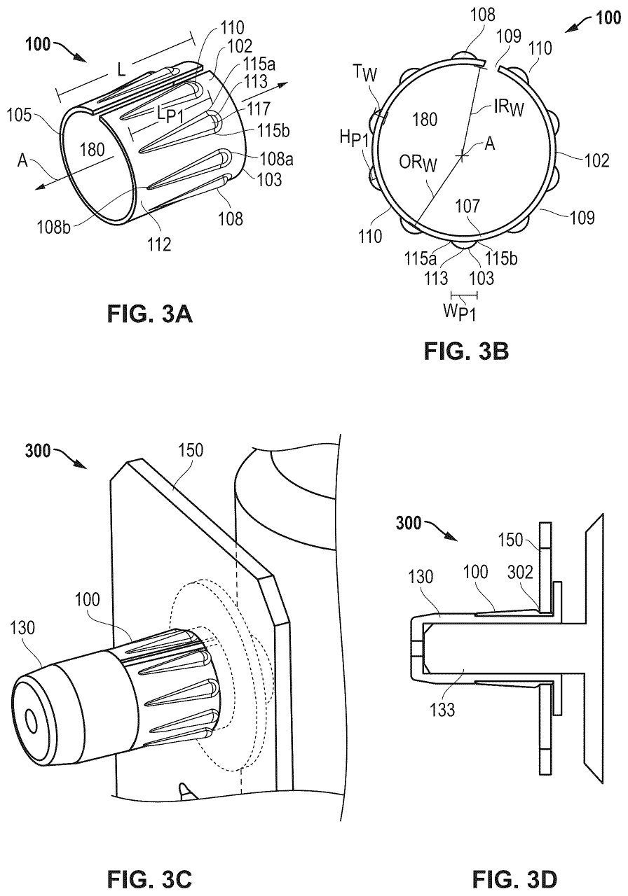

FIG. 2A includes an illustration of the composite material 1000 that may be formed according to first step 12 and second step 14 of the forming process 10 for producing a fastener in accordance with an embodiment described above. For purposes of illustration, FIG. 2A shows the layer by layer configuration of a composite material 1000 after second step 14. In a number of embodiments, the composite material 1000 may include a substrate 1119 (i.e., the base material provided in the first step 12) and a low friction layer or insulating layer 1104 (i.e., the low friction coating applied in second step 14). As shown in FIG. 2A, the low friction layer 1104 can be coupled to at least a portion of the substrate 1119. In a particular embodiment, the low friction layer 1104 can be coupled to a surface of the substrate 1119 so as to form a low friction interface with another surface of another component. The low friction layer 1104 can be coupled to the radially inner surface of the substrate 1119 so as to form a low friction interface with another surface of another component. The low friction layer 1104 can be coupled to the radially outer surface of the substrate 1119 so as to form a low friction interface with another surface of another component.

In a number of embodiments, the low friction layer 1104 can include a low friction material. Low friction materials may include, for example, a polymer, such as a polyketone, a polyaramid, a polyimide, a polytherimide, a polyphenylene sulfide, a polyethersulfone, a polysulfone, a polyphenylene sulfone, a polyamideimide, ultra high molecular weight polyethylene, a fluoropolymer, a polyamide, a polybenzimidazole, or any combination thereof. In an example, the low friction layer 1104 includes a polyketone, a polyaramid, a polyimide, a polyetherimide, a polyamideimide, a polyphenylene sulfide, a polyphenylene sulfone, a fluoropolymer, a polybenzimidazole, a derivative thereof, or a combination thereof. In a particular example, the low friction/wear resistant layer includes a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the low friction/wear resistant layer includes polyketone, such as polyether ether ketone (PEEK), polyether ketone, polyether ketone ketone, polyether ketone ether ketone, a derivative thereof, or a combination thereof. In an additional example, the low friction/wear resistant layer may be an ultra high molecular weight polyethylene. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. The low friction layer 1104 may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, lead, iron, bronze, steel, spring steel, stainless steel), a metal alloy (including the metals listed), an anodized metal (including the metals listed) or any combination thereof. Fluoropolymers may be used according to particular embodiments. As used herein, a “low friction material” can be a material having a dry static coefficient of friction as measured against steel of less than 0.5, such as less than 0.4, less than 0.3, or even less than 0.2. A “high friction material” can be a material having a dry static coefficient of friction as measured against steel of greater than 0.6, such as greater than 0.7, greater than 0.8, greater than 0.9, or even greater than 1.0. The low friction layer 1104 may be an electrically non-conductive or low-conductive sliding material, e.g. includes a material that is non-conductive or low-conductive. For this reason, in a number of embodiments, the low friction layer 1104 may be considered as an insulating layer as described herein.

In a number of embodiments, the low friction layer 1104 may further include fillers, including glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof. Fillers can be in the form of beads, fibers, powder, mesh, or any combination thereof. The fillers may be at least 1 wt % based on the total weight of the low friction layer, such as at least 5 wt %, or even 10 wt % based on the total weight of the low friction layer.

The substrate 1119 can have a thickness Ts of between about 10 microns to about 1500 microns, such as between about 50 microns and about 1000 microns, such as between about 100 microns and about 750 microns, such as between about 350 microns and about 650 microns. In a number of embodiments, the substrate 1119 may have a thickness Ts of between about 700 and 800 microns. In a number of embodiments, the substrate 1119 may have a thickness Ts of between about 950 and 1050 microns. It will be further appreciated that the thickness Ts of the substrate 1119 may be any value between any of the minimum and maximum values noted above. The thickness of the substrate 1119 may be uniform, i.e., a thickness at a first location of the substrate 1119 can be equal to a thickness at a second location therealong. The thickness of the substrate 1119 may be non-uniform, i.e., a thickness at a first location of the substrate 1119 can be different from a thickness at a second location therealong.

In an embodiment, the low friction layer 1104 can have a thickness T_{SL} of between about 1 micron to about 500 microns, such as between about 10 microns and about 350 microns, such as between about 30 microns and about 300 microns, such as between about 40 microns and about 250 microns. In a number of embodiments, the low friction layer 1104 may have a thickness T_{SL} of between about 50 and 300 microns. It will be further appreciated that the thickness T_{SL} of the low friction layer 1104 may be any value between any of the minimum and maximum values noted above. The thickness of the low friction layer 1104 may be uniform, i.e., a thickness at a first location of the low friction layer 1104 can be equal to a thickness at a second location therealong. The thickness of the low friction layer 1104 may be non-uniform, i.e., a thickness at a first location of the low friction layer 1104 can be different from a thickness at a second location therealong. It can be appreciated that different low friction layers 1104 may have different thicknesses. The low friction layer 1104 may overlie one major surface of the substrate 1119, shown, or overlie both major surfaces. The substrate 1119 may be at least partially encapsulated by the low friction layer 1104. That is, the low friction layer 1104 may cover at least a portion of the substrate 1119. Axial surfaces of the substrate 1119 may be exposed from the low friction layer 1104.

FIG. 2B includes an illustration of an alternative embodiment of the composite material that may be formed according to first step 12 and second step 14 of the forming process 10 for producing a fastener in accordance with an embodiment described above. For purposes of illustration, FIG. 2B shows the layer by layer configuration of a composite material 1002 after second step 14. According to this particular embodiment, the composite material 1002 may be similar to the composite material 1000 of FIG. 2A, except this composite material 1002 may also include at least one adhesive layer 1121 that may couple the low friction layer 1104 to the substrate 1119 (i.e., the base material provided in the first step 12) and a low friction layer 1104 (i.e., the low friction coating applied in second step 14). In another alternate embodiment, the substrate 1119, as a solid component, woven mesh, or expanded metal grid, may be embedded between at least one adhesive layer 1121 included between the low friction layer 1104 and the substrate 1119.

The adhesive layer 1121 may include any known adhesive material common to the fastener arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C., or even higher than 300° C. The adhesive layer 1121 can have a thickness of about 1 to 50 microns, such as about 7 to 15 microns. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C., or even higher than 300° C.

The adhesive layer 1121 can have a thickness TAL of between about 1 micron to about 80 microns, such as between about 10 microns and about 50 microns, such as between about 20 microns and about 40 microns. In a number of embodiments, the adhesive layer 1121 may have a thickness T_{AL} of between about 3 and 20 microns. In a number of embodiments, the adhesive layer 1121 may have a thickness T_{AL} of between about 10 and 60 microns. It will be further appreciated that the thickness T_{AL} of the adhesive layer 1121 may be any value between any of the minimum and maximum values noted above. The thickness of the adhesive layer 1121 may be uniform, i.e., a thickness at a first location of the adhesive layer 1121 can be equal to a thickness at a second location therealong. The thickness of the adhesive layer 1121 may be non-uniform, i.e., a thickness at a first location of the adhesive layer 1121 can be different from a thickness at a second location therealong.

FIG. 2C includes an illustration of an alternative embodiment of the composite material that may be formed according to first step 12 and second step 14 of the forming process 10 for producing a fastener in accordance with an embodiment described above. For purposes of illustration, FIG. 2C shows the layer by layer configuration of a composite material 1003 after second step 14. According to this particular embodiment, the composite material 1003 may be similar to the composite material 1002 of FIG. 2B, except this composite material 1003 may also include at least one corrosion protection layer 1704, 1705, and 1708, and a corrosion resistant coating 1124 that can include an adhesion promoter layer 1127 and an epoxy layer 1129 that may couple to the substrate 1119 (i.e., the base material provided in the first step 12) and a low friction layer 1104 (i.e., the low friction coating applied in second step 14).

The substrate 1119 may be coated with corrosion protection layers 1704 and 1705 to prevent corrosion of the composite material 1003 prior to processing. Additionally, a corrosion protection layer 1708 can be applied over layer 1704. Each of layers 1704, 1705, and 1708 can have a thickness of about 1 to 50 microns, such as about 7 to 15 microns. Layers 1704 and 1705 can include a phosphate of zinc, iron, manganese, or any combination thereof, or a nano-ceramic layer. Further, layers 1704 and 1705 can include functional silanes, nano-scaled silane based primers, hydrolyzed silanes, organosilane adhesion promoters, solvent/water based silane primers, chlorinated polyolefins, passivated surfaces, commercially available zinc (mechanical/galvanic) or zinc-nickel coatings, or any combination thereof. Layer 1708 can include functional silanes, nano-scaled silane based primers, hydrolyzed silanes, organosilane adhesion promoters, solvent/water based silane primers. Corrosion protection layers 1704, 1706, and 1708 can be removed or retained during processing.

The composite material 1003 may further include a corrosion resistant coating 1125. The corrosion resistant coating 1125 can have a thickness of about 1 to 50 microns, such as about 5 to 20 microns, and such as about 7 to 15 microns. The corrosion resistant coating 1125 can include an adhesion promoter layer 1127 and an epoxy layer 1129. The adhesion promoter layer 1127 can include a phosphate of zinc, iron, manganese, tin, or any combination thereof, or a nano-ceramic layer. The adhesion promoter layer 1127 can include functional silanes, nano-scaled silane based layers, hydrolyzed silanes, organosilane adhesion promoters, solvent/water based silane primers, chlorinated polyolefins, passivated surfaces, commercially available zinc (mechanical/galvanic) or Zinc-Nickel coatings, or any combination thereof. The epoxy layer 1129 can be a thermal cured epoxy, a UV cured epoxy, an IR cured epoxy, an electron beam cured epoxy, a radiation cured epoxy, or an air cured epoxy. Further, the epoxy layer 1129 can include polyglycidylether, diglycidylether, bisphenol A, bisphenol F, oxirane, oxacyclopropane, ethylenoxide, 1,2-epoxypropane, 2-methyloxirane, 9,10-epoxy-9,10-dihydroanthracene, or any combination thereof. The epoxy layer 1129 can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners, polyamides, or any combination thereof. Generally, acid anhydrides can conform to the formula R—C═O—O—C—O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof.

In an embodiment, under step 14 of FIG. 1, any of the layers on the composite material 1000, 1002, 1003, as described above, can each be disposed in a roll and peeled therefrom to join together under pressure, at elevated temperatures (hot or cold pressed or rolled), by an adhesive, or by any combination thereof. Any of the layers of the composite material 1000, as described above, may be laminated together such that they at least partially overlap one another. Any of the layers on the composite material 1000, 1002, 1003, as described above, may be applied together using coating technique, such as, for example, physical or vapor deposition, spraying, plating, powder coating, or through other chemical or electrochemical techniques. In a particular embodiment, the low friction layer 1104 may be applied by a roll-to-roll coating process, including for example, extrusion coating. The low friction layer 1104 may be heated to a molten or semi-molten state and extruded through a slot die onto a major surface of the substrate 1119. In another embodiment, the low friction layer 1104 may be cast or molded.

In an embodiment, the low friction layer 1104 or any layers can be glued to the substrate 1119 using the melt adhesive layer 1121 to form a laminate. In an embodiment, any of the intervening or outstanding layers on the material or composite material 1000, 1002, 1003, may form the laminate. The laminate can be cut into strips or blanks that can be formed into the fastener. The cutting of the laminate may include use of a stamp, press, punch, saw, or may be machined in a different way. Cutting the laminate can create cut edges including an exposed portion of the substrate 1119.

In other embodiments, under step 14 of FIG. 1, any of the layers on the composite material 1000, 1002, 1003, as described above, may be applied by a coating technique, such as, for example, physical or vapor deposition, spraying, plating, powder coating, or through other chemical or electrochemical techniques. In a particular embodiment, the low friction layer 1104 may be applied by a roll-to-roll coating process, including for example, extrusion coating. The low friction layer 1104 may be heated to a molten or semi-molten state and extruded through a slot die onto a major surface of the substrate 1119. In another embodiment, the low friction layer 1104 may be cast or molded.

Referring now to the third step 16 of the forming process 10 as shown in FIG. 1, according to certain embodiments, forming the composite material 1000, 1002, 1003 into a fastener may include a cutting operation. In an embodiment, the cutting operation may include use of a stamp, press, punch, saw, deep draw, or may be machined in a different way. In a number of embodiments, the cutting operation may form a peripheral surface on the fastener. The cutting operation may define a cutting direction initiated from a first major surface to a second major surface, opposite the first major surface, to form the peripheral surfaces or edges. Alternatively, the cutting operation may define a cutting direction initiated from the second major surface to the first major surface to form the peripheral surfaces or edges.

After shaping the fastener, the fastener may be cleaned to remove any lubricants and oils used in the forming and shaping process. Additionally, cleaning can prepare the exposed surface of the substrate for the application of the coating. Cleaning may include chemical cleaning with solvents and/or mechanical cleaning, such as ultrasonic cleaning.

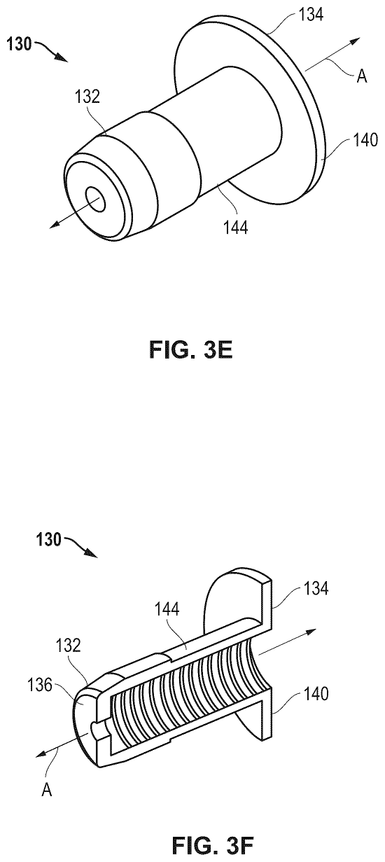

Turning now to the fastener formed according to embodiments described herein, for purposes of illustration, FIG. 3A includes a side perspective view illustration of a fastener 100 formed from a blank of material or composite material 1000, 1001, 1002, 1003 as described using the forming process above for producing a fastener in accordance with an embodiment described above. For purposes of illustration, FIG. 3B shows a top view of a fastener 100 formed from a blank of material or composite material 1000, 1001, 1002, 1003 as described using the forming process above for producing a fastener in accordance with an embodiment described above, which can include a fastener body 102 oriented about a central axis A. The fastener body 102 may be formed from a blank as described above and include a substrate (e.g. spring steel) that may be curved into a ring-like (substantially annular) shape about a central axis A, forming an aperture 180. The fastener body 102 may further include a low friction layer that conforms to the shape of the substrate, as formed as a low friction layer from the blank of composite material 1000, 1001, 1002, 1003 as described above. The fastener body 102 may further include a sidewall 104. The ends of the sidewall 104 may not meet (e.g., it may be formed as a split ring), thereby leaving an axial gap 119 adjacent the circumference of the sidewall 104. In other embodiments, the sidewall 104 may be curved so that the ends overlap with one another. In yet further embodiments, the sidewall 104 may be a continuous, unbroken ring. The sidewall 104 may include a first axial end 103 and a second axial end 105. The sidewall 104 may include a first radial surface 107 and a second radial surface 109 oriented down the central axis A with each defining a peripheral surface of the fastener 100. The first radial surface 107 may have a low friction layer that conforms to the shape of the sidewall 104 with the substrate, as formed from the composite material 1000, 1001, 1002, 1003 as described above. Alternatively or additionally, the second radial surface 109 may have a low friction layer that conforms to the shape of the sidewall 104, as formed from the composite material 1000, 1001, 1002, 1003 as described above. In other embodiments, the low friction layer may be laminated onto both surfaces of the first radial surface 107 and the second radial surface 109 of the sidewall 104. The sidewall 104 may have a polygonal, arcuate, at least partially arcuate, oval, circular, semi-circular, or substantially circular cross-section when viewed in a plane perpendicular to the central axis A. The first radial surface 107 may at least partially define the aperture 180 in the fastener 100. In some embodiments, the fastener 100 may further include at least one radial taper disposed along at least one of the first radial surface 107 and the second radial surface 109 of the sidewall 104.

In a number of embodiments, as shown in FIG. 3A, the fastener 100 may have an overall length L. For purposes of embodiments described herein, the overall length L of the fastener 100 is the distance from the first axial end 103 to the second axial end 105. According to certain embodiment, the overall length L of the fastener 100 may be at least about 1 mm, such as, at least about 10 mm, or at least about 20 mm, or at least about 30 mm, or at least about 40 mm, or even at least about 50 mm. According to still other embodiments, the overall length L of the fastener 100 may be not greater than about 100 mm, such as, not greater than about 50 mm or even not greater than about 25 mm. It will be appreciated that the overall length L of the fastener 100 may be within a range between any of the minimum and maximum values noted above. It will be further appreciated that the overall length L of the fastener 100 may be any value between any of the minimum and maximum values noted above. For example, the overall length L of the fastener 100 may be 4 mm. The inner radius IR_{W} may coincide with the radius of the aperture 180.

In a number of embodiments, as shown in FIG. 3B, the fastener 100 may have an overall outer radius OR_{W}. For purposes of embodiments described herein, the outer radius OR_{W} of the fastener 100 is the distance from the central axis A to the second radial surface 109. According to certain embodiment, the outer radius OR_{W} of the fastener 100 may be at least about 1 mm, such as, at least about 10 mm, or at least about 20 mm, or at least about 30 mm, or at least about 40 mm, or even at least about 50 mm. According to still other embodiments, the outer radius OR_{W} of the fastener 100 may be not greater than about 100 mm, such as, not greater than about 50 mm, or even not greater than about 25 mm. It will be appreciated that the outer radius OR_{W} of the fastener 100 may be within a range between any of the minimum and maximum values noted above. It will be further appreciated that the outer radius OR_{W} of the fastener 100 may be any value between any of the minimum and maximum values noted above. For example, the outer radius OR_{W} of the fastener 100 may be 7.5 mm.

In a number of embodiments, as shown in FIG. 3B, the fastener 100 may have an overall inner radius IR_{W}. For purposes of embodiments described herein, the inner radius IR_{W} of the fastener 100 is the distance from the central axis A to the first radial surface 107. According to certain embodiment, the inner radius IR_{W} of the fastener 100 may be at least about 1 mm, such as, at least about 10 mm, or at least about 20 mm, or at least about 30 mm, or at least about 40 mm, or even at least about 50 mm. According to still other embodiments, the inner radius IR_{W} of the fastener 100 may be not greater than about 100 mm, such as, not greater than about 50 mm, or even not greater than about 25 mm. It will be appreciated that the inner radius IR_{W} of the fastener 100 may be within a range between any of the minimum and maximum values noted above. It will be further appreciated that the inner radius IR_{W} of the fastener 100 may be any value between any of the minimum and maximum values noted above. For example, the inner radius IR_{W} of the fastener 100 may be 4 mm. The inner radius IR_{W} may coincide with the radius of the aperture 180.

In a number of embodiments, as shown in FIG. 3B, the fastener 100 may have a particular axial height T_{W}. For purposes of embodiments described herein and as shown in FIG. 3B, the axial height T_{W} of the fastener 100 is the distance from the first radial surface 107 to the second radial surface 109. According to certain embodiment, the axial height T_{W} of the fastener 100 may be at least about 0.01 mm, such as, at least about 0.1 mm, or at least about 0.2 mm, or at least about 0.3 mm, or at least about 0.4 mm, or even at least about 0.5 mm. According to still other embodiments, the axial height T_{W} of the fastener 100 may be not greater than about 10 mm, such as, not greater than about 5 mm, or even not greater than about 1 mm. It will be appreciated that the axial height T_{W} of the fastener 100 may be within a range between any of the minimum and maximum values noted above. It will be further appreciated that the axial height T_{W} of the fastener 100 may be any value between any of the minimum and maximum values noted above. For example, the axial height T_{W} of the fastener 100 may be 1.3 mm.

As shown in FIGS. 3A-3B, the fastener 100 may have at least one first type of projection 108 projecting axially from the fastener body 102 relative to the central axis A. The first type of projections 108 may be formed from the composite material 1000, 1001, 1002, 1003 via stamping (e.g., pressed using a suitably shaped mold, rotary wave forming, etc.), pressing, cutting, or via another method. The projection 108 may be deformable as described in further detail below. The at least one first type of projection 108 may project or extend axially inward from the first radial surface 107 of the fastener body 102 relative to the central axis A. The at least one first type of projection 108 may project or extend axially outward from the second radial surface 109 of fastener body 102 relative to the central axis A. The fastener 100 may include a plurality of first type of projections 108 that extend radially inward and/or outward from the first axial surface 106 and/or the second axial surface 108 of the fastener 100. The first type of projection 108 may be continuous around the circumference of the sidewall 104 (e.g. wave) or discontinuous around the circumference of the sidewall 104 (e.g. dimple). The first type of projections 108 may be adapted to contact a mating component as described below.

The first type of projections 108 may be axially-elongated ridges (i.e. circumferential waves). In an embodiment, the first type of projection 108 may be rounded or rectilinear. In an embodiment, at least two of the first type of projections 108 may have the same geometric shape or size as compared to each other. In a further embodiment, all of the first type of projections 108 may have the same geometric shape or size as compared to each other. In another embodiment, at least one of the first type of projections 108 may have different geometric shapes or sizes as compared to each other. In a further embodiment, all of the first type of projections 108 may have different geometric shapes or sizes as compared to each other.

As shown in FIGS. 3A-3B, at least one of the first type of projections 108 may have a circumferential width, W_{P1}, defined between a pair of bases 115a, 115b, an axial length, L_{P1}, and a radial height H_{P1}, and a circumferential hump 113 extending in the radial direction, the hump 113 rising to and falling from an apex 117 within the circumferential width, W_{P1}. The apex 117 of the at least one first type of projection 108 may be rounded or squared. The circumferential width, W_{P1}, and axial length, L_{P1}, may be any value within the overall inner radius I_{W} and the overall outer radius OR_{W} of the push on fastener 100 described above. The radial height, H_{P1}, may be any value within the radial height T_{W} of the push on fastener 100 described above.

As shown in FIGS. 3A-3B, at least one of the first type of projections 108 may have a radial face 110 having a shaped cross-section when viewed in a plane perpendicular to the central axis A. In a number of embodiments, the shaped cross-section of the radial face 110 may be polygonal, arcuate, at least partially arcuate, oval, circular, semi-circular, or substantially circular. In a number of embodiments, the shaped cross-section of the radial face 110 may be teardrop shape as shown in FIGS. 3A-3B. In a number of embodiments, the teardrop shaped radial face 100 may taper in circumferential width W_{P} in the axial direction down central axis A, between a first axial end 108a and a second axial end 108b.

In a number of embodiments, the sidewall 104 may include at least one unformed rim section 112 disposed on the sidewall 104 near at least one axial end 103, 105 of the fastener 100 above or below the first type of projections 108. In a number of embodiments, each first type of projection 108 also may be spaced from its neighboring first type of projections 108 by an unformed section 110, which may be contiguously formed with and spaced circumferentially, radially, or axially between a first pair of adjacent first type of projections 108, as discussed in further detail below.

In operation, the fastener 100 may be located adjacent to an opposing component within an assembly 300. FIG. 3C includes a top perspective view of a fastener 100 within an assembly 300 in accordance with an embodiment. FIG. 3D includes a cross-sectional side view of a fastener 100 within an assembly 300 in accordance with an embodiment. It will be appreciated that corresponding components between FIGS. 3A-3D (i.e., components having the same reference number) may be described as having any of the characteristics or features described in reference to any of the other figures disclosed herein. In a number of embodiments, as shown in FIGS. 3C and 3D, the fastener 100 may be located, mounted, or otherwise disposed in an axial gap 302 between two opposing (mating) components (e.g. such as in a bore in the outer component 150 into which the inner component 130 and fastener 100 are disposed). For example, it may be located in the annular space between an inner component 130 and an outer component 150. In a number of embodiments, the inner component 130 may be a fastener, housing, a side member, or other structural member in the assembly 300. In a number of embodiments, the inner component 130 may be coupled with the component of a frame of a vehicle component such as a seatback assembly. In a number of embodiments, the outer component 150 may be a fastener, housing, a side member, or other structural member in the assembly 300. In a number of embodiments, the outer component 150 may be coupled with the component of an airbag assembly including an airbag. In an embodiment, the outer component 150 may be adapted to rotate or translate relative to the inner component 130. In another embodiment, the inner component 130 may be adapted to rotate or translate relative to the outer component 150. The fastener 100 can be disposed adjacent to, or contacting, an inner component 130 in an assembly 300. In a number of embodiments, the fastener 100 may be installed on the inner component 130 in the assembly 300. The fastener 100 can be disposed adjacent to, or contacting, an outer component 150 in an assembly 300. In a number of embodiments, the fastener 100 may be installed on the outer component 150 in the assembly 300.

In a number of embodiments, the first type of projections 108 may be deformed or compressed between the inner and outer components 130, 150. In some embodiments, the first type of projections 108 may act as a spring and deform to fit the components together with zero clearance therebetween. In other words, the inner component 130 contacts the first radial surface 107 of the fastener 100 and the outer component 150 contacts the second radial surface 109 of the fastener 100. In an embodiment, as shown in FIGS. 3C-3D, the first type of projections 108 may form an axial stop, restricting axial or rotational movement of at least one of the inner component 130 and the outer component 150 relative to one another. In a number of embodiments, at least one first type of projection 108 may have a deformable spring rate of not greater than 30 kN/mm, such as not greater than 25 kN/mm, such as not greater than 15 kN/mm, or such as not greater than 10 kN/mm. In a number of embodiments, at least one first type of projection 108 may have a spring rate of at least 10 N/mm, such as at least 100 N/mm, or such as at least 500 N/mm. The spring rate may vary depending on the size of the first type of projection 108, the thickness of the fastener 100, and other dimensions of the fastener 100.

In a number of embodiments, as shown in FIG. 3D, the inner component 130 may include an adapter and be coupled with an additional inner component 133. The adapter may at least partially surround the additional inner component 133 and be in contact with the fastener 100. FIG. 3E includes a top perspective side view of an inner component 130 within an assembly 300 in accordance with embodiments described above and herein. FIG. 3F includes a cross-sectional side view of an inner component 130 within an assembly 300 in accordance with embodiments described above and herein. It will be appreciated that corresponding components between FIGS. 3A-3F (i.e., components having the same reference number) may be described as having any of the characteristics or features described in reference to any of the other figures disclosed herein. As shown in FIGS. 3E-3F, the inner component 130 may include a body 132 having first and second axial ends 134, 136. The body 132 may have a polygonal, arcuate, at least partially arcuate, oval, circular, semi-circular, or substantially circular cross-section when viewed in a plane perpendicular to the central axis A. In a number of embodiments, the body 132 of the inner component 130 may include at least one flange 140 at at least one of the first and second axial ends 134, 136. In a number of embodiments, the at least one flange 140 may project radially outwardly from at least one of the first axial end 134 or the second axial end 136. Alternatively, the at least one flange 140 may project radially inwardly from at least one of the first axial end 134 or the second axial end 136. In a number of embodiments, the flange 140 may be uniform around a circumference of the inner component 130 about the central axis A. Alternatively, in a number of embodiments, the flange 140 may include a plurality of axial splits to form a segmented flange. The flange 140 may have a polygonal, arcuate, at least partially arcuate, oval, circular, semi-circular, or substantially circular cross-section when viewed in a plane perpendicular to the central axis A. In a number of embodiments, as shown in FIGS. 3E-3F, the body 132 of the inner component 132 may include at least one radial groove 144. The at least one radial groove 144 may be located down the body 132 along its axial length along the central axis A. In a number of embodiments, the at least one radial groove 144 may be adapted to fit the fastener 100 described herein. In an embodiment, the at least one radial groove may axially house the fastener 100 such that it may snap-fit onto the inner component 130. In an embodiment, the at least one radial groove may not allow for axial or radial movement of the fastener 100 such that it is effectively coupled with the inner component 130.

In a number of embodiments, the adapter/inner component 130 can include a polymer, such as a polyketone, a polyaramid, a polyimide, a polytherimide, a polyphenylene sulfide, a polyethersulfone, a polysulfone, a polyphenylene sulfone, a polyamideimide, ultra high molecular weight polyethylene, a fluoropolymer, a polyamide, a polybenzimidazole, or any combination thereof. In an example, the adapter/inner component 130 includes a polyketone, a polyaramid, a polyimide, a polyetherimide, a polyamideimide, a polyphenylene sulfide, a polyphenylene sulfone, a fluoropolymer, a polybenzimidazole, a derivative thereof, or a combination thereof. In a particular example, the low friction/wear resistant layer includes a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the adapter/inner component 130 includes polyketone, such as polyether ether ketone (PEEK), polyether ketone, polyether ketone ketone, polyether ketone ether ketone, a derivative thereof, or a combination thereof. In an additional example, the low friction/wear resistant layer may be an ultra high molecular weight polyethylene. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. In a number of embodiments, the adapter/inner component 130 may be injection molded.

According to embodiments herein, a method of assembly is shown. The method may include providing an inner component 130, an outer component 150, and a fastener 100. The method may further include positioning the fastener 100 between the inner component 130 and the outer component 150, the fastener 100 including a sidewall 104 oriented about a central axis A, the sidewall 104 including at least one first type of deformable projection 108 including a teardrop shaped radial face 110. The method may further include contacting the sidewall 104 of the fastener 100 to at least one of the inner component 130 or the outer component 150.

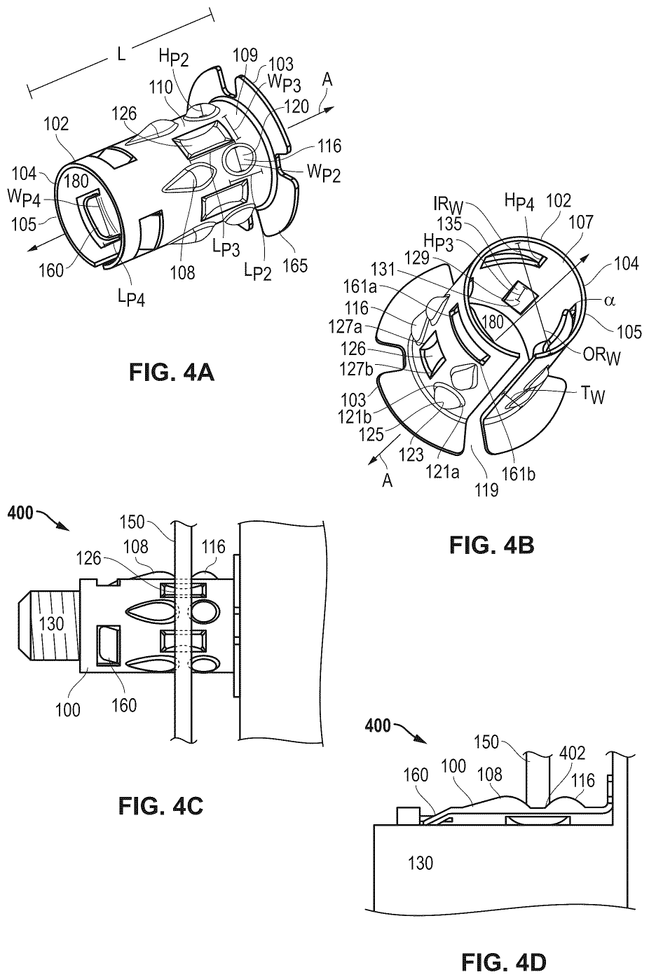

Turning now to another embodiment of the fastener formed according to embodiments described herein, for purposes of illustration, FIG. 4A includes a side perspective view illustration of a fastener 100 formed from a blank of material or composite material 1000, 1001, 1002, 1003 as described using the forming process above for producing a fastener in accordance with an embodiment described above. For purposes of illustration, FIG. 4B shows an end view of a fastener 100 formed from a blank of material or composite material 1000, 1001, 1002, 1003 as described using the forming process above for producing a fastener in accordance with an embodiment described above, which can include a fastener body 102 oriented about a central axis A. It will be appreciated that corresponding components between FIGS. 4A-4B (i.e., components having the same reference number) may be described as having any of the characteristics or features described in reference to any of the other figures disclosed herein. The fastener body 102 may be formed from a blank as described above and include a substrate (e.g. spring steel) that may be curved into a ring-like (substantially annular) shape about a central axis A, forming an aperture 180. The fastener body 102 may further include a low friction layer that conforms to the shape of the substrate, as formed as a low friction layer from the blank of composite material 1000, 1001, 1002, 1003 as described above. The fastener body 102 may further include a sidewall 104. The ends of the sidewall 104 may not meet (e.g., it may be formed as a split ring), thereby leaving an axial gap 119 adjacent to the circumference of the sidewall 104. In other embodiments, the sidewall 104 may be curved so that the ends overlap with one another. In yet further embodiments, the sidewall 104 may be a continuous, unbroken ring. The sidewall 104 may include a first axial end 103 and a second axial end 105. The sidewall 104 may include a first radial surface 107 and a second radial surface 109 oriented down the central axis A with each defining a peripheral surface of the fastener 100. The first radial surface 107 may have a low friction layer that conforms to the shape of the sidewall 104 with the substrate, as formed from the composite material 1000, 1001, 1002, 1003 as described above. Alternatively or additionally, the second radial surface 109 may have a low friction layer that conforms to the shape of the sidewall 104, as formed from the composite material 1000, 1001, 1002, 1003 as described above. In other embodiments, the low friction layer may be laminated onto both surfaces of the first radial surface 107 and the second radial surface 109 of the sidewall 104. The sidewall 104 may have a polygonal, arcuate, at least partially arcuate, oval, circular, semi-circular, or substantially circular cross-section when viewed in a plane perpendicular to the central axis A. The first radial surface 107 may at least partially define the aperture 180 in the fastener 100. In some embodiments, the fastener 100 may further include at least one radial taper disposed along at least one of the first radial surface 107 and the second radial surface 109 of the sidewall 104. In a number of embodiments, as shown in FIG. 4B, the fastener 100 may have an overall length L, an overall outer radius OR_{W}, an overall inner radius IR_{W}, and an axial height T_{W} of similar ranges noted above regarding the fastener dimensions embodied herein.

As shown in FIGS. 4A-4B, the fastener 100 may have at least one first type of projection 108 projecting axially from the fastener body 102 relative to the central axis A. The at least one first type of projection 108 may have similar characteristics and dimensions to those noted above in FIGS. 3A-3B.

As shown in FIGS. 4A-4B, the fastener 100 may have at least one second type of projection 116 projecting axially from the fastener body 102 relative to the central axis A. The second type of projection 116 may be formed from the composite material 1000, 1001, 1002, 1003 via stamping (e.g., pressed using a suitably shaped mold, rotary wave forming, etc.), pressing, cutting, or via another method. The projection 116 may be deformable as described in further detail below. The at least one second type of projection 116 may project or extend axially inward from the first radial surface 107 of the fastener body 102 relative to the central axis A. The at least one second type of projection 116 may project or extend axially outward from the second radial surface 109 of fastener body 102 relative to the central axis A. The fastener 100 may include a plurality of second type of projections 116 that extend radially inward and/or outward from the first axial surface 106 and/or the second axial surface 108 of the fastener 100. The second type of projection 116 may be continuous around the circumference of the sidewall 104 (e.g. wave) or discontinuous around the circumference of the sidewall 104 (e.g. dimple). The second type of projections 116 may be adapted to contact a mating component as described below.

The second type of projections 116 may be axially-elongated ridges (i.e. circumferential waves). In an embodiment, the second type of projections 116 may be rounded or rectilinear. In an embodiment, at least two of the second type of projections 116 may have the same geometric shape or size as compared to each other. In a further embodiment, all of the second type of projections 116 may have the same geometric shape or size as compared to each other. In another embodiment, at least one of the second type of projections 116 may have different geometric shapes or sizes as compared to each other. In a further embodiment, all of the second type of projections 116 may have different geometric shapes or sizes as compared to each other.

As shown in FIGS. 4A-4B, at least one of second type of projections 116 may have a circumferential width, W_{P2}, defined between a pair of bases 121a, 121b, an axial length, L_{P2}, and a radial height H_{P2}, and a circumferential hump 123 extending in the radial direction, the hump 123 rising to and falling from an apex 125 within the circumferential width, W_{P2}. The apex 125 of the at least one second type of projection 116 may be rounded or squared. The circumferential width, W_{P2} and axial length, L_{P2}, may be any value within the overall inner radius IR_{W} and the overall outer radius OR_{W} of the push on fastener 100 described above. The radial height, H_{P2}, may be any value within the radial height T_{W} of the push on fastener 100 described above.

As shown in FIGS. 4A-4B, at least one of the second type of projections 116 may have a radial face 120 having a shaped cross-section when viewed in a plane perpendicular to the central axis A. In a number of embodiments, the shaped cross-section of the radial face 120 may be polygonal, arcuate, at least partially arcuate, oval, circular, semi-circular, or substantially circular. In a number of embodiments, the shaped cross-section of the radial face 120 may be a substantially arcuate shape as shown in FIGS. 4A-4B. In a number of embodiments, the shaped cross-section of the radial face 120 may be a substantially circular shape.

In a number of embodiments, each second type of projection 116 also may be spaced from its neighboring second type of projection 116 by an unformed section 110, which may be contiguously formed with and spaced circumferentially, radially, or axially between a first pair of second type of projection 116. Further, the unformed section 110 may include space between the second type of projection 116 and the first type of projection 108. In a number of embodiments, the at least one second type of deformable projection 116 may be disposed axially above the radial face 110 of the at least one first type of deformable projection 108 along the central axis A. In a number of embodiments, the at least one second type of deformable projection 116 may be disposed axially below the radial face 110 of the at least one first type of deformable projection 108 along the central axis A. In a number of embodiments, the at least one second type of deformable projection 116 may be axially aligned with the radial face 110 of the at least one first type of deformable projection 108 along the central axis A. In a number of embodiments, the at least one second type of deformable projection 116 may be axially offset with the radial face 110 of the at least one first type of deformable projection 108 along the central axis A.

As shown in FIGS. 4A-4B, the fastener 100 may have at least one third type of projection 126 projecting axially from the fastener body 102 relative to the central axis A. The third type of projection 126 may be formed from the composite material 1000, 1001, 1002, 1003 via stamping (e.g., pressed using a suitably shaped mold, rotary wave forming, etc.), pressing, cutting, or via another method. The third type of projection 126 may be deformable as described in further detail below. The at least one third type of projection 126 may project or extend axially inward from the first radial surface 107 of the fastener body 102 relative to the central axis A. The at least one third type of projection 126 may project or extend axially outward from the second radial surface 109 of fastener body 102 relative to the central axis A. The fastener 100 may include a plurality of third type of projections 126 that extend radially inward and/or outward from the first axial surface 106 and/or the second axial surface 108 of the fastener 100. The third type of projection 126 may be continuous around the circumference of the sidewall 104 (e.g. wave) or discontinuous around the circumference of the sidewall 104 (e.g. dimple). The third type of projection 126 may be adapted to contact a mating component as described below.

The third type of projections 126 may be axially-elongated ridges (i.e. circumferential waves). In an embodiment, the third type of projection 126 may be rounded or rectilinear. In an embodiment, at least two of the third type of projections 126 may have the same geometric shape or size as compared to each other. In a further embodiment, all of the third type of projections 126 may have the same geometric shape or size as compared to each other. In another embodiment, at least one of the third type of projections 126 may have different geometric shapes or sizes as compared to each other. In a further embodiment, all of the third type of projections 126 may have different geometric shapes or sizes as compared to each other.

As shown in FIGS. 4A-4B, at least one of third type of projections 126 may have a circumferential width, W_{P3}, defined between a pair of bases 127a, 127b, and a radial height H_{P3}, and a circumferential hump 129 extending in the radial direction, the hump 123 rising to and falling from an apex 131 within the circumferential width, W_{P3}. The apex 125 of the at least one third type of projection 126 may be rounded or squared. The circumferential width, W_{P3}, may be any value within the overall inner radius IR_{W} and the overall outer radius OR_{W} of the push on fastener 100 described above. The radial height, H_{P3}, may be any value within the radial height T_{W} of the push on fastener 100 described above.

As shown in FIGS. 4A-4B, at least one of the third type of projections 126 may have a radial face 135 having a shaped cross-section when viewed in a plane perpendicular to the central axis A. In a number of embodiments, the shaped cross-section of the radial face 135 may be polygonal, arcuate, at least partially arcuate, oval, circular, semi-circular, or substantially circular. In a number of embodiments, the shaped cross-section of the radial face 135 may be a substantially polygonal shape as shown in FIGS. 3A-3B. In a number of embodiments, the shaped cross-section of the radial face 120 may be a substantially rectilinear shape.

In a number of embodiments, each third type of projection 126 also may be spaced from its neighboring third type of projection 126 by an unformed section 110, which may be contiguously formed with and spaced circumferentially, radially, or axially between a first pair of third type of projection 126. Further, the unformed section 110 may include space between the third type of projection 126 and the first type of projection 108 and/or the third type of projection 126 and the second type of projection 116. In a number of embodiments, the at least one third type of projection 126 may be disposed axially above at least one of the radial face 110 of the at least one first type of deformable projection 108 or the radial face 120 of the at least one first type of deformable projection 116 along the central axis A. In a number of embodiments, the at least one third type of projection 126 may be disposed axially below at least one of the radial face 110 of the at least one first type of deformable projection 108 or the radial face 120 of the at least one first type of deformable projection 116 along the central axis A. In a number of embodiments, the at least one third type of projection 126 may be axially aligned with at least one of the radial face 110 of the at least one first type of deformable projection 108 or the radial face 120 of the at least one first type of deformable projection 116 along the central axis A. In a number of embodiments, the at least one third type of projection 126 may be axially offset with at least one of the radial face 110 of the at least one first type of deformable projection 108 or the radial face 120 of the at least one first type of deformable projection 116 along the central axis A. In a number of embodiments, the at least one third type of projection 126 may be disposed circumferentially between at least one of the radial face 110 of the at least one first type of deformable projection 108 or the radial face 120 of the at least one first type of deformable projection 116.

As shown in FIGS. 4A-4B, the fastener 100 may have at least one fourth type of projection 160 projecting axially from the fastener body 102 relative to the central axis A. The fourth type of projection 160 may be formed from the composite material 1000, 1001, 1002, 1003 via stamping (e.g., pressed using a suitably shaped mold, rotary wave forming, etc.), pressing, cutting, or via another method. The fourth type of projection 160 may be deformable as described in further detail below. The at least one fourth type of projection 160 may project or extend axially inward from the first radial surface 107 of the fastener body 102 relative to the central axis A. The at least one fourth type of projection 160 may project or extend axially outward from the second radial surface 109 of fastener body 102 relative to the central axis A. The fastener 100 may include a plurality of fourth type of projections 160 that extend radially inward and/or outward from the first axial surface 106 and/or the second axial surface 108 of the fastener 100. The fourth type of projections 160 may be continuous around the circumference of the sidewall 104 (e.g. wave) or discontinuous around the circumference of the sidewall 104 (e.g. dimple). The fourth type of projections 160 may be adapted to contact a mating component as described below.

The fourth type of projection 160 may be a radial tine extending in the radial direction. The fourth type of projection 160 can be continuously connected to the sidewall along one side and continuously disconnected from the sidewall 104 along the remaining sides. As used herein, “continuously disconnected” refers to a single disconnection or gap between the projection 160 and the sidewall 104. In such a manner, the projection 160 can be attached to the sidewall 104 along only one side. In a number of embodiments, the fourth type of projection 160 may have any two-dimensional cross-sectional shape when viewed in when viewed in a plane perpendicular to the central axis A including a polygonal profile, a circular profile, an oval profile, an ellipsis profile, or may form a different shaped profile. In an embodiment, at least two of the fourth type of projection 160 may have the same geometric shape or size as compared to each other. In a further embodiment, all of the fourth type of projection 160 may have the same geometric shape or size as compared to each other. In another embodiment, at least one of the fourth type of projection 160 may have different geometric shapes or sizes as compared to each other. In a further embodiment, all of the fourth type of projection 160 may have different geometric shapes or sizes as compared to each other.

In a number of embodiments, the fourth type of projection 160 may be canted. The cant of the radial tine of the fourth type of projection 160 may form an angle a with respect to the plane parallel to the sidewall 104 and the central axis A. By way of a non-limiting embodiment, the angle α can be at least 0.1°, such as at least 2°, at least 4°, at least 5°, or even at least 10°. In another embodiment, the angle α can be no greater than 45°, such as no greater than 40°, no greater than 35°, no greater than 30°, no greater than 25°, or even no greater than 20°. In still another embodiment, the angle α can be no less than or equal to 30°. It will be appreciated that the angle α may be within a range between any of the minimum and maximum values noted above. It will be further appreciated that the angle a may be any value between any of the minimum and maximum values noted above.

As shown in FIGS. 4A-4B, at least one of fourth type of projections 160 may have a circumferential width, W_{P4}, defined between a pair of bases 161a, 161b, an axial length, L_{P4}, and a radial height H_{P4}. The apex 125 of the at least one third type of projection 126 may be rounded or squared. The circumferential width, W_{P4}, and axial length, L_{P4}, may be any value within the overall inner radius IR_{W} and the overall outer radius OR_{W} of the push on fastener 100 described above. The radial height, H_{P4}, may be any value within the radial height T_{W} of the push on fastener 100 described above.

In a number of embodiments, each fourth type of projection 160 also may be spaced from its neighboring fourth type of projection 160 by an unformed section 110, which may be contiguously formed with and spaced circumferentially, radially, or axially between a first pair of fourth type of projections 160. Further, the unformed section 110 may include space between the fourth type of projections 160 and the first type of projections 108, the second type of projections 116, and/or the third type of projections 126. In a number of embodiments, the at least one fourth type of projections 160 may be disposed axially above at least one of the radial face 110 of the at least one first type of deformable projection 108, the radial face 120 of the at least one first type of deformable projection 116, or the radial face 135 of the at least one third type of deformable projection 126 along the central axis A. In a number of embodiments, the at least one fourth type of projections 160 may be disposed axially below at least one of the radial face 110 of the at least one first type of deformable projection 108, the radial face 120 of the at least one second type of deformable projection 116, or the radial face 135 of the at least one third type of deformable projection 126 along the central axis A. In a number of embodiments, the at least one fourth type of projections 160 may be axially aligned with at least one of the radial face 110 of the at least one first type of deformable projection 108, the radial face 120 of the at least one second type of deformable projection 116, or the radial face 135 of the at least one third type of deformable projection 126 along the central axis A. In a number of embodiments, the at least one fourth type of projections 160 may be axially offset with at least one of the radial face 110 of the at least one first type of deformable projection 108, the radial face 120 of the at least one second type of deformable projection 116, or the radial face 135 of the at least one third type of deformable projection 126 along the central axis A.

In a number of embodiments, as shown in FIGS. 4A-4B, the body 102 of the fastener 100 may include at least one flange 165 at at least one of the first and second axial ends 103, 105. In a number of embodiments, the at least one flange 165 may project radially outwardly from at least one of the first axial end 103 or the second axial end 105. Alternatively, the at least one flange 165 may project radially inwardly from at least one of the first axial end 103 or the second axial end 105. In a number of embodiments, the flange 165 may be uniform around a circumference of the inner component 130 about the central axis A. Alternatively as shown in FIGS. 4A-4B, in a number of embodiments, the flange 165 may include a plurality of axial splits to form a segmented flange. The flange 165 may have a polygonal, arcuate, at least partially arcuate, oval, circular, semi-circular, or substantially circular cross-section when viewed in a plane perpendicular to the central axis A.

In operation, the fastener 100 may be located adjacent to an opposing component within an assembly 400. FIG. 4C includes a side view of a fastener 100 within an assembly 400 in accordance with an embodiment. FIG. 4D includes a cross-sectional side view of a fastener 100 within an assembly 300 in accordance with an embodiment. It will be appreciated that corresponding components between FIGS. 4A-4D (i.e., components having the same reference number) may be described as having any of the characteristics or features described in reference to any of the other figures disclosed herein. In a number of embodiments, as shown in FIGS. 4C and 4D, the fastener 100 may be located, mounted, or otherwise disposed in an axial gap 402 between two opposing (mating) components (e.g. such as in a bore in the outer component 150 into which the inner component 130 and fastener 100 are disposed). For example, it may be located in the annular space between an inner component 130 and an outer component 150. In a number of embodiments, the inner component 130 may be a fastener, housing, a side member, or other structural member in the assembly 400. In a number of embodiments, the inner component 130 may be coupled with the component of a frame of a vehicle component such as a seatback assembly. In a number of embodiments, the outer component 150 may be a fastener, housing, a side member, or other structural member in the assembly 400. In a number of embodiments, the outer component 150 may be coupled with the component of an airbag assembly including an airbag. In an embodiment, the outer component 150 may be adapted to rotate or translate relative to the inner component 130. In another embodiment, the inner component 130 may be adapted to rotate or translate relative to the outer component 150. The fastener 100 can be disposed adjacent to, or contacting, an inner component 130 in an assembly 400. In a number of embodiments, the fastener 100 may be installed on the inner component 130 in the assembly 400. The fastener 100 can be disposed adjacent to, or contacting, an outer component 150 in an assembly 400. In a number of embodiments, the fastener 100 may be installed on the outer component 150 in the assembly 400.

In a number of embodiments, at least one of the first type of projections 108, the second type of projections 116, the third type of projections 126, or the fourth type of projections 160 may be deformed or compressed between the inner and outer components 130, 150. In some embodiments, at least one of the first type of projections 108, the second type of projections 116, the third type of projections 126, or the fourth type of projections 160 may act as a spring and deforms to fit the components 130, 150 together with zero clearance therebetween. In other words, the inner component 130 contacts the first radial surface 107 of the fastener 100 and the outer component 150 contacts the second radial surface 109 of the fastener 100. In an embodiment, as shown in FIGS. 3C-3D, the at least one of the first type of projections 108, the second type of projections 116, the third type of projections 126, or the fourth type of projections 160 may form an axial stop, restricting axial or rotational movement of at least one of the inner component 130 and the outer component 150 relative to one another. In an embodiment, as shown in FIGS. 4C-4D, the first type of projections 108 and the second type of projections 116 may form an axial stop, restricting axial or rotational movement of the outer component 150 as the outer component 150 is located within an axial space between the two. Further, as shown in FIGS. 4C-4D, the third type of projection 126 may form an axial stop, restricting axial or rotational movement of the outer component 150 circumferentially offset from the first type of projections 108 and the second type of projections 116. Further, as shown in FIGS. 4C-4D, the fourth type of projection 160 may form an axial stop, restricting axial or rotational movement of the inner component 130 by contacting the inner component 130. In a number of embodiments, at least one of the first type of projections 108, the second type of projections 116, the third type of projections 126, or the fourth type of projections 160 may have a deformable spring rate of not greater than 30 kN/mm, such as not greater than 25 kN/mm, such as not greater than 15 kN/mm, or such as not greater than 10 kN/mm. In a number of embodiments, at least one of the first type of projections 108, the second type of projections 116, the third type of projections 126, or the fourth type of projections 160 may have a spring rate of at least 10 N/mm, such as at least 100 N/mm, or such as at least 500 N/mm. The spring rate may vary depending on the size of the projection, the thickness of the fastener 100, and other dimensions of the fastener 100.

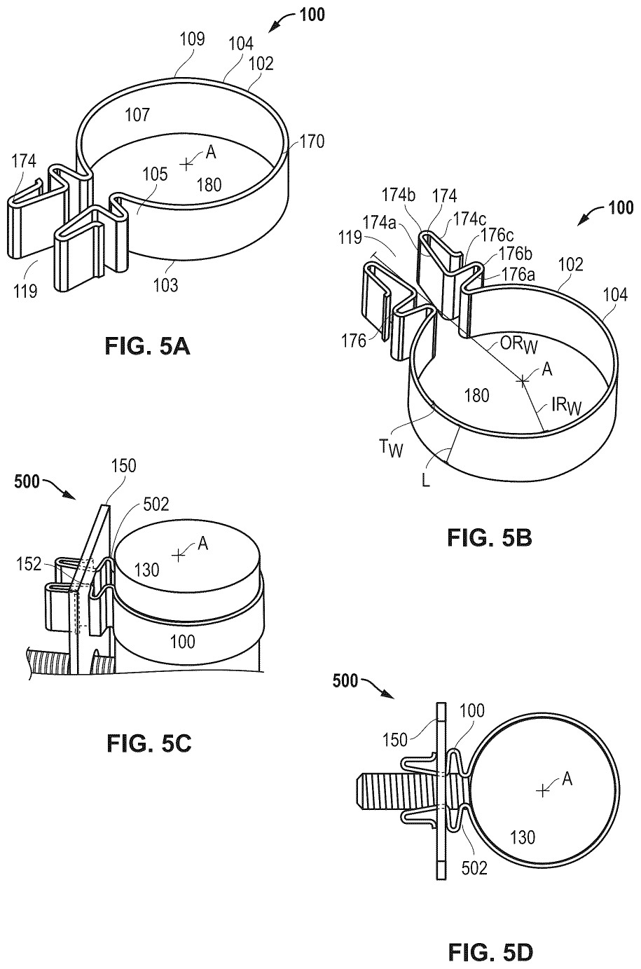

Turning now to another embodiment of a the fastener formed according to embodiments described herein, for purposes of illustration, FIG. 5A includes a side perspective view illustration of a fastener 100 formed from a blank of material or composite material 1000, 1001, 1002, 1003 as described using the forming process above for producing a fastener in accordance with an embodiment described above. For purposes of illustration, FIG. 5B shows a top view of a fastener 100 formed from a blank of material or composite material 1000, 1001, 1002, 1003 as described using the forming process above for producing a fastener in accordance with an embodiment described above, which can include a fastener body 102 oriented about a central axis A. It will be appreciated that corresponding components between FIGS. 5A-5B (i.e., components having the same reference number) may be described as having any of the characteristics or features described in reference to any of the other figures disclosed herein.

The fastener body 102 may be formed from a blank as described above and include a substrate (e.g. spring steel) that may be curved into a ring-like (substantially annular) shape perpendicular to a central axis A, forming an aperture 180. The fastener body 102 may further include a low friction layer that conforms to the shape of the substrate, as formed as a low friction layer from the blank of composite material 1000, 1001, 1002, 1003 as described above. The fastener body 102 may further include a sidewall 104. The ends of the sidewall 104 may not meet (e.g., it may be formed as a split ring), thereby leaving an axial gap 119 adjacent the circumference of the sidewall 104. The sidewall 104 may include a first axial end 103 and a second axial end 105. The sidewall 104 may include a first radial surface 107 and a second radial surface 109 oriented down the central axis A with each defining a peripheral surface of the fastener 100. The first radial surface 107 may have a low friction layer that conforms to the shape of the sidewall 104 with the substrate, as formed from the composite material 1000, 1001, 1002, 1003 as described above. Alternatively or additionally, the second radial surface 109 may have a low friction layer that conforms to the shape of the sidewall 104, as formed from the composite material 1000, 1001, 1002, 1003 as described above. In other embodiments, the low friction layer may be laminated onto both surfaces of the first radial surface 107 and the second radial surface 109 of the sidewall 104. The sidewall 104 may have a polygonal, arcuate, at least partially arcuate, oval, circular, semi-circular, or substantially circular cross-section when viewed in a plane perpendicular to the central axis A. The first radial surface 107 may at least partially define the aperture 180 in the fastener 100. In some embodiments, the fastener 100 may further include at least one radial taper disposed along at least one of the first radial surface 107 and the second radial surface 109 of the sidewall 104. In a number of embodiments, as shown in FIG. 5B, the fastener 100 may have an overall length L, an overall outer radius OR_{W}, an overall inner radius IR_{W}, and an axial height T_{W} of similar ranges noted above regarding the fastener dimensions embodied herein.

As shown in FIGS. 5A-5B, the sidewall 104 of the fastener 100 may have at least one arcuate portion 170. The arcuate portion 170 may be formed from the composite material 1000, 1001, 1002, 1003 via stamping (e.g., pressed using a suitably shaped mold, rotary wave forming, etc.), pressing, cutting, or via another method. The arcuate portion 170 may be deformable. The arcuate portion 170 may further include an arcuate, at least partially arcuate, oval, circular, semi-circular, or substantially circular cross-section when viewed in a plane perpendicular to the central axis A. In a number of embodiments, the arcuate portion 170 may be disposed at a second radial end of the fastener 100 as shown in FIGS. 5A-5B.

As shown in FIGS. 5A-5B, the sidewall 104 of the fastener 100 may have at least one radial corrugation portion 174. The at least one radial corrugation portion 174 may be formed from the composite material 1000, 1001, 1002, 1003 via stamping (e.g., pressed using a suitably shaped mold, rotary wave forming, etc.), pressing, cutting, or via another method. The at least one radial corrugation portion 174 may be deformable. The at least one radial corrugation portion 174 may further include an arcuate, polygonal, at least partially arcuate, oval, circular, semi-circular, or substantially circular cross-section when viewed in a plane perpendicular to the central axis A. The at least one radial corrugation portion 174 may include a plurality of radial corrugation portions 174. In a number of embodiments, the at least one radial corrugation portion 174 may include a radial projection portion 174a, a bridge portion 174b, and a radial recession portion 174c. In a number of embodiments, the radial recession portion 174c may have an end that is curved radially outward as shown in FIGS. 5A-5B. Any dimensions of the radial projection portion 174a, a bridge portion 174b, and a radial recession portion 174c are contemplated as being within similar ranges regarding the overall length L, the overall outer radius OR_{W}, the overall inner radius IR_{W}, and the axial height T_{W} noted above regarding the fastener dimensions embodied herein. In a number of embodiments, the radial corrugation portion 174 may be disposed at a first radial end of the fastener 100 opposite the arcuate corrugation portion 170 as shown in FIGS. 5A-5B.

As shown in FIGS. 5A-5B, the sidewall 104 of the fastener 100 may have at least one circumferential corrugation portion 176. The at least one circumferential corrugation portion 176 may be formed from the composite material 1000, 1001, 1002, 1003 via stamping (e.g., pressed using a suitably shaped mold, rotary wave forming, etc.), pressing, cutting, or via another method. The at least one circumferential corrugation portion 176 may be deformable. The at least one circumferential corrugation portion 176 may further include an arcuate, polygonal, at least partially arcuate, oval, circular, semi-circular, or substantially circular cross-section when viewed in a plane perpendicular to the central axis A. The at least one circumferential corrugation portion 176 may include a plurality of circumferential corrugation portions 176. In a number of embodiments, the at least one circumferential corrugation portion 176 may include a radial projection portion 176a, a bridge portion 176b, and a radial recession portion 176c. Any dimensions of the radial projection portion 176a, a bridge portion 176b, and a radial recession portion 176c are contemplated as being within similar ranges regarding the overall length L, the overall outer radius OR_{W}, the overall inner radius IR_{W}, and the axial height T_{W} noted above regarding the fastener dimensions embodied herein. In a number of embodiments, the circumferential corrugation portion 176 may be disposed radially between the radial corrugation portion 174 and the arcuate corrugation portion 170 as shown in FIGS. 5A-5B.

In operation, the fastener 100 may be located adjacent to an opposing component within an assembly 500. FIG. 5C includes a top perspective view of a fastener 100 within an assembly 500 in accordance with an embodiment. FIG. 5D includes a cross-sectional top view of a fastener 100 within an assembly 500 in accordance with an embodiment. It will be appreciated that corresponding components between FIGS. 5A-5D (i.e., components having the same reference number) may be described as having any of the characteristics or features described in reference to any of the other figures disclosed herein. In a number of embodiments, as shown in FIGS. 5C and 5D, the fastener 100 may be located, mounted, or otherwise disposed in a radial gap 502 between two opposing (mating) components 130, 150. For example, it may be located in the annular space between an inner component 130 and an outer component 150. In a number of embodiments, the inner component 130 may be a fastener, housing, a side member, or other structural member in the assembly 500. In a number of embodiments, the inner component 130 may be coupled with the component of a frame of a vehicle component such as seatback assembly. In a number of embodiments, the outer component 150 may be a fastener, housing, a side member, or other structural member in the assembly 500. In a number of embodiments, the outer component 150 may be coupled with the component of an airbag assembly including an airbag. In an embodiment, the outer component 150 may be adapted to rotate or translate relative to the inner component 130. In another embodiment, the inner component 130 may be adapted to rotate or translate relative to the outer component 150. The fastener 100 can be disposed adjacent to, or contacting, an inner component 130 in an assembly 500. In a number of embodiments, the fastener 100 may be installed on the inner component 130 in the assembly 500. The fastener 100 can be disposed adjacent to, or contacting, an outer component 150 in an assembly 500. In a number of embodiments, the fastener 100 may be installed on the outer component 150 in the assembly 500.

In a number of embodiments, as shown in FIGS. 5C-5D, the arcuate portion 170 of the fastener 100 may at least partially surround the inner component 130 to couple the inner component 130 and the fastener 100. In a number of embodiments, the outer component 150 may couple to the fastener 100 between the radial corrugation portion 174 and the circumferential corrugation portion 176 as shown. In a number of embodiments, the fastener 100 may deform to allow the outer component 150 to be disposed between the radial corrugation portion 174 and the circumferential corrugation portion 176. In a number of embodiments, the outer component 150 may include at least one bore 152 into which the radial corrugation portion 174 may slide through use of the deformable radial projection portion 174a, a bridge portion 174b, and a radial recession portion 174c to couple the outer component 150 and the fastener 100. In a number of embodiments, the end of the radial recession portion 174 may contact the outer component 150 to fix against the outer component 150 as shown. In some embodiments, at least one of the radial corrugation portion 174 or the circumferential corrugation portion 176 may act as a spring and deforms to fit the components 130, 150 together. In other words, the inner component 130 contacts the first radial surface 107 of the fastener 100 and the outer component 150 contacts the second radial surface 109 of the fastener 100. In an embodiment, as shown in FIGS. 3C-3D, the radial corrugation portion 174 and the circumferential corrugation portion 176 may form a radial stop, restricting axial or rotational movement of at least one of the inner component 130 and the outer component 150 relative to one another. In a number of embodiments, at least one of the radial corrugation portion 174 or the circumferential corrugation portion 176 may have a deformable spring rate of not greater than 30 kN/mm, such as not greater than 25 kN/mm, such as not greater than 15 kN/mm, or such as not greater than 10 kN/mm. In a number of embodiments, at least one of the radial corrugation portion 174 or the circumferential corrugation portion 176 may have a spring rate of at least 10 N/mm, such as at least 100 N/mm, or such as at least 500 N/mm. The spring rate may vary depending on the size of least one of the radial corrugation portion 174 or the circumferential corrugation portion 176, the thickness of the fastener 100, and other dimensions of the fastener 100.

According to embodiments herein, a method of assembly is shown. The method may include providing an inner component 130 including a frame, an outer component 150 including an airbag, and a fastener 100. The method may further include positioning the fastener 100 between the inner component 130 and the outer component 150, the fastener 100 including a sidewall 104 oriented about a central axis A, the sidewall 104 including an arcuate portion 170, a radial corrugation portion 174, and a circumferential corrugation portion 176, where the sidewall 100 is a layered structure including a substrate and an insulating layer overlying the substrate. The method may further include contacting the sidewall 104 of the fastener 100 to at least one of the inner component 130 or the outer component 150 so as to fix the radial corrugation portion 174 against the outer component 150.

In a further embodiment, the fasteners 100 in the assemblies 300, 400, 500, according to embodiments herein can be installed or assembled by an assembly force of no greater than 10,000 N in the radial direction to the inner member 130 or outer member 150, such as no greater than 5,000 N, no greater than 1,000 N, no greater than 500 N, no greater than 100 N, no greater than 50, or even no greater than 10 N. In a number of embodiments, the fastener 100 in the assemblies 300, 400, 500, according to embodiments herein can be installed or assembled by an assembly force of less than 200 N. In a number of embodiments, the fastener 100 in the assemblies 300, 400, 500, according to embodiments herein can be installed or assembled by an assembly force of more than 300 N. It will be appreciated that the assembly force of the fastener 100 may be within a range between any of the minimum and maximum values noted above. It will be further appreciated that the assembly force of the fastener 100 may be any value between any of the minimum and maximum values noted above.

Applications for embodiments include, for example, assemblies for mechanical assemblies and/or vehicle component assemblies. Further, use of the fastener or assembly may provide increased benefits in several applications such as, but not limited to, airbag, frame, suspension, door, hood, tailgate, and engine compartment hinges, seats, seatbacks, steering columns, flywheels, driveshaft assemblies, powertrain applications (such as belt tensioners), or other types of applications. According to particular embodiments herein, the fastener may provide improved stiffness and fulfill sliding/retention force requirements across neighboring components in assemblies compared to conventional fasteners. The use of these fasteners may replace existing fasteners in these assemblies (notably airbag and airbag related assemblies for vehicles). In addition, fasteners according to embodiments herein may decrease noise/vibration, reduce wear of the fastener surface and the mating components and reduce complex componentry and assembly time, thereby increasing lifetime, improving visual appearance and spacing, and improving effectiveness and performance of the assembly, the fastener, and its other components.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A fastener comprising: a sidewall oriented about a central axis, the sidewall comprising at least one first type of deformable projection comprising a teardrop shaped radial face.

Embodiment 2: A fastener comprising: a sidewall oriented about a central axis, the sidewall comprising an arcuate portion, a radial corrugation portion, and a circumferential corrugation portion, wherein the sidewall is a layered structure comprising a substrate and an insulating layer overlying the substrate, wherein the fastener is adapted to secure an airbag to a frame of an assembly.

Embodiment 3: An assembly, comprising: an outer component including a bore within the outer component; an inner component disposed within the bore; and a fastener mounted between the inner component and the outer component, the fastener comprising: a sidewall oriented about a central axis, the sidewall comprising at least one first type of deformable projection comprising a teardrop shaped radial face.

Embodiment 4: An assembly, comprising: an outer component comprising an airbag; an inner component comprising a frame; and a fastener mounted between the inner component and the outer component, the fastener comprising: a sidewall oriented about a central axis, the sidewall comprising an arcuate portion, a radial corrugation portion, and a circumferential corrugation portion, wherein the sidewall is a layered structure comprising a substrate and an insulating layer overlying the substrate.

Embodiment 5: A method, comprising: providing an inner component and an outer component; positioning a fastener between the inner component and the outer component, the fastener comprising: a sidewall oriented about a central axis, the sidewall comprising at least one first type of deformable projection comprising a teardrop shaped radial face; and contacting the sidewall of the fastener to at least one of the inner component or the outer component.

Embodiment 6: A method, comprising: providing an inner component comprising an airbag and an outer component comprising a frame; positioning a fastener between the inner component and the outer component, the fastener comprising: a sidewall oriented about a central axis, the sidewall comprising an arcuate portion, a radial corrugation portion, and a circumferential corrugation portion, wherein the sidewall is a layered structure comprising a substrate and an insulating layer overlying the substrate; and contacting the sidewall of the fastener to at least one of the inner component or the outer component so as to fix the radial corrugation portion against the outer component.

Embodiment 7: The fastener, assembly, or method of any one of embodiments 1, 3, and 5, wherein the fastener comprises a layered structure comprising a substrate and an insulating layer.

Embodiment 8: The fastener, assembly, or method of any one of embodiments 2, 4, 6, and 7, wherein the substrate comprises a metal.

Embodiment 9: The fastener, assembly, or method of any one of embodiments 2, 4, 6, and 7, wherein the substrate comprises a metal, wherein the metal comprises a carbon steel or stainless steel.

Embodiment 10: The fastener, assembly, or method of any one of embodiments 2, 4, 6, and 7, wherein the low friction layer comprises a polymer.

Embodiment 11: The fastener, assembly, or method of any one of embodiments 2, 4, 6, and 7, wherein the insulating layer comprises a polyketone, polyaramid, a polyimide, a polyetherimide, a polyphenylene sulfide, a polyethersulfone, a polysulfone, a polyphenylene sulfone, a polyamideimide, ultra high molecular weight polyethylene, a fluoropolymer, a polyamide, a polybenzimidazole, or any combination thereof.

Embodiment 12: The fastener, assembly, or method of any one of embodiments 1, 3, and 5, wherein the teardrop shaped radial face of the at least one first type of deformable projection extends radially inward from the sidewall.

Embodiment 13: The fastener, assembly, or method of any one of embodiments 1, 3, and 5, wherein the teardrop shaped radial face of the at least one first type of deformable projection extends radially outward from the sidewall.

Embodiment 14: The fastener, assembly, or method of any one of embodiments 1, 3, and 5, wherein the sidewall comprises a gap along its axial length.

Embodiment 15: The fastener, assembly, or method of any one of embodiments 1, 3, and 5, wherein the sidewall further comprises unformed portions between at least two neighboring projections.

Embodiment 16: The fastener, assembly, or method of any one of embodiments 1, 3, and 5, wherein the sidewall further comprises unformed rim sections neighboring axial ends of the sidewall.

Embodiment 17: The assembly or method of any one of embodiments 3 and 5, wherein the inner component comprises an injection molded polymer.

Embodiment 18: The assembly, or method of any one of embodiments 3 and 5, wherein the inner component comprises a first axial end comprising a radial flange.

Embodiment 19: The assembly or method of any one of embodiments 3 and 5, wherein the inner component comprises a radial groove along its axial length adapted to fit the fastener.

Embodiment 20: The fastener, assembly, or method of any one of embodiments 1, 3, and 5, wherein the sidewall comprises a first axial end comprising a radial flange.

Embodiment 21: The fastener, assembly, or method of embodiment 20, wherein the radial flange is segmented.

Embodiment 22: The fastener, assembly, or method of any one of embodiments 1, 3, and 5, wherein the sidewall further comprises at least one second type of deformable projection.

Embodiment 23: The fastener, assembly, or method of embodiment 22, wherein the at least one second type of deformable projection comprising an arcuate shaped radial face.

Embodiment 24: The fastener, assembly, or method of embodiment 22, wherein the arcuate shaped radial face of the at least one second type of deformable projection extends radially inward from the sidewall.

Embodiment 25: The fastener, assembly, or method of embodiment 22, wherein the arcuate shaped radial face of the at least one second type of deformable projection extends radially outward from the sidewall.

Embodiment 26: The fastener, assembly, or method of embodiment 22, wherein the at least one second type of deformable projection is disposed axially above the teardrop shaped radial face of the at least one first type of deformable projection.

Embodiment 27: The fastener, assembly, or method of embodiment 22, wherein the at least one second type of deformable projection is disposed axially below the teardrop shaped radial face of the at least one first type of deformable projection.

Embodiment 28: The fastener, assembly, or method of any one of embodiments 1, 3, and 5, wherein the sidewall further comprises at least one third type of deformable projection.

Embodiment 29: The fastener, assembly, or method of embodiment 28, wherein the at least one third type of deformable projection comprising a rectilinear shaped radial face.

Embodiment 30: The fastener, assembly, or method of embodiment 28, wherein the rectilinear shaped radial face of the at least one third type of deformable projection extends radially inward from the sidewall.

Embodiment 31: The fastener, assembly, or method of embodiment 28, wherein the rectilinear shaped radial face of the at least one third type of deformable projection extends radially outward from the sidewall.

Embodiment 32: The fastener, assembly, or method of embodiment 28, wherein the at least one third type of deformable projection is disposed circumferentially between the teardrop shaped radial face of neighboring first type of deformable projections.

Embodiment 33: The fastener, assembly, or method of any one of embodiments 1, 3, and 5, wherein the sidewall further comprises at least one fourth type of deformable projection.

Embodiment 34: The fastener, assembly, or method of embodiment 33, wherein the at least one fourth type of deformable projection comprising a radial tine.

Embodiment 35: The fastener, assembly, or method of embodiment 33, wherein the radial tine of the at least one fourth type of deformable projection extends radially inward from the sidewall.

Embodiment 36: The fastener, assembly, or method of embodiment 33, wherein the radial tine of the at least one fourth type of deformable projection extends radially outward from the sidewall.

Embodiment 37: The fastener, assembly, or method of embodiment 33, wherein the at least one fourth type of deformable projection is disposed axially above the teardrop shaped radial face of the at least one first type of deformable projection.

Embodiment 38: The fastener, assembly, or method of embodiment 33, wherein the at least one fourth type of deformable projection is disposed axially below the teardrop shaped radial face of the at least one first type of deformable projection.

Embodiment 39: The fastener, assembly, or method of any one of embodiments 2, 4, and 6, wherein the radial corrugation portion of the sidewall is disposed at a first radial end of the fastener.

Embodiment 40: The fastener, assembly, or method of any one of embodiments 2, 4, and 6, wherein the arcuate portion of the sidewall is disposed at a second radial end of the fastener.

Embodiment 41: The fastener, assembly, or method of any one of embodiments 2, 4, and 6, wherein the circumferential corrugation portion is disposed between the radial corrugation portion and the arcuate portion of the sidewall.

Embodiment 42: The fastener, assembly, or method of any one of embodiments 1 to 6, wherein the fastener has an assembly force of less than about 200 N.

Embodiment 43: The fastener, assembly, or method of any one of embodiments 1 to 6, wherein the fastener has a retention force of more than about 300 N.

Note that not all of the features described above are required, that a region of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of assembly and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A fastener comprising:
a sidewall oriented about a central axis, the sidewall comprising at least one first type of deformable projection comprising a teardrop shaped radial face.

2. A fastener comprising:
a sidewall oriented about a central axis, the sidewall comprising an arcuate portion, a radial corrugation portion, and a circumferential corrugation portion, wherein the sidewall is a layered structure comprising a substrate and an insulating layer overlying the substrate, wherein the fastener is adapted to secure an airbag to a frame of an assembly.

3. An assembly comprising:
an outer component including a bore within the outer component;
an inner component disposed within the bore; and
a fastener mounted between the inner component and the outer component, the fastener comprising:
a sidewall oriented about a central axis, the sidewall comprising at least one first type of deformable projection comprising a teardrop shaped radial face.

4. The fastener of claim 1, wherein the fastener comprises a layered structure comprising a substrate and an insulating layer.

5. The fastener of claim 4, wherein the substrate comprises a metal.

6. The fastener of claim 4, wherein the insulating layer comprises a polymer.

7. The fastener of claim 1, wherein the teardrop shaped radial face of the at least one first type of deformable projection extends radially inward from the sidewall.

8. The fastener of claim 1, wherein the teardrop shaped radial face of the at least one first type of deformable projection extends radially outward from the sidewall.

9. The fastener of claim 1, wherein the sidewall comprises a first axial end comprising a radial flange.

10. The fastener of claim 9, wherein the radial flange is segmented.

11. The fastener of claim 1, wherein the sidewall further comprises at least one second type of deformable projection.

12. The fastener of claim 11, wherein the at least one second type of deformable projection comprises an arcuate shaped radial face.

13. The fastener of claim 1, wherein the sidewall further comprises at least one third type of deformable projection.

14. The fastener of claim 13, wherein the at least one third type of deformable projection comprises a rectilinear shaped radial face.

15. The fastener of claim 13, wherein the at least one third type of deformable projection is disposed circumferentially between the teardrop shaped radial face of neighboring first type of deformable projections.

16. The fastener of claim 1, wherein the sidewall further comprises at least one fourth type of deformable projection.

17. The fastener of claim 16, wherein the at least one fourth type of deformable projection comprises a radial tine.

18. The fastener of claim 2, wherein the radial corrugation portion of the sidewall is disposed at a first radial end of the fastener.

19. The fastener of claim 2, wherein the arcuate portion of the sidewall is disposed at a second radial end of the fastener.

20. The fastener of claim 2, wherein the circumferential corrugation portion is disposed between the radial corrugation portion and the arcuate portion of the sidewall.
